(19) United States
(12) Patent Application Publication
(10) Pub. No.: US 2009/0015043 A1
(43) Pub. Date: Jan. 15, 2009

(54) Vehicle Seat Comprising an Air Conditioning Unit

(75) Inventors: Alwin Macht, Ebensfeld (DE); Daniela Stegner, Neustadt (DE); Steffen Brosius, Weitramsdorf (DE)

Correspondence Address: KING & SPALDING, 1185 AVENUE OF THE AMERICAS, NEW YORK, NY, 10036-4003, US

(73) Assignee: Brose Farhzeugteile GmbH & Co. Kommanditgesellschaft, Coburg, Coburg (DE)

(21) Appl. No.: 12/138,061

(22) Filed: Jun. 12, 2008

(30) Foreign Application Priority Data
Jun. 14, 2007 (DE) 20 2007 008 310.6

(51) Int. Cl. B60N 2/56; A47C 7/74; A47C 31/00

(52) U.S. Cl. 297/180.14; 297/452.42

(57) ABSTRACT

The vehicle seat comprises an air conditioning unit associated with the seat pan and/or the backrest. The air conditioning unit comprises a fan, a flow channel and an air distribution element arranged on the upper face of the seat pan and/or backrest upholstery and connected to the fan via the flow channel. A fan receptacle and the flow channel are molded into the seat pan and/or into the backrest.

### FIELD OF THE INVENTION

The invention relates to a vehicle seat comprising an air conditioning unit associated with the seat pan and/or the backrest. The air conditioning unit comprises a fan, a flow channel and an air distribution element arranged on the upper face of the seat pan and/or the backrest upholstery and connected to the fan via the flow channel.

### BACKGROUND OF THE INVENTION

Such an air conditioning unit for a vehicle seat is known from DE 103 16 275 A1. The seat pan and the backrest of the vehicle seat are formed in a shell-like manner. The seat pan is configured for receiving the seat pan upholstery and the backrest is configured for receiving the backrest upholstery. The seat pan and the backrest upholstery have on their upper face a plurality of flow channels connected to one another and incorporated in the upholstery. At the same time, the flow channels of the seat pan upholstery and the flow channels of the backrest upholstery merge with one another. The flow channels of the seat pan upholstery and the backrest upholstery are covered by air distribution elements configured as air distribution mats. Such an air distribution mat is, for example, disclosed in DE 203 203 72 U1. The air distribution mats are fixed by means of an air-permeable cushion cover to the seat pan upholstery or to the backrest upholstery. An axial fan is arranged to the side on the backrest, via which the flow channels of the upholstery may be impinged by conveyed air. As a whole, therefore, the back, the seat and the upper leg of a person sitting on the motor vehicle seat are impinged by a flow of conveyed air. By means of the air distribution mats, conveyed air is distributed uniformly over the entire surface of the upholstery of the seat pan and the backrest. In DE 103 50 191 A1 an air conditioning unit for a vehicle seat is disclosed, in which both the amount of air, and the air temperature of the conveyed air flow may be predetermined.

### SUMMARY OF THE INVENTION

The object of the invention is to improve structurally the design of the air-conditioning of a vehicle seat.

To this end, a fan receptacle and at least one flow channel are molded into the seat pan and/or into the backrest. In this manner, a retrospective insertion of the fan receptacle into the seat pan and/or backrest configured in the manner of a shell is not necessary for attaching the fan. Moreover, the costly insertion of the flow channels into the surface of the seat pan and/or backrest upholstery is dispensed with. Instead, the seat pan and/or the backrest may be provided with conventional upholstery. The air conditioning unit is, therefore, able to be designed considerably more cost-effectively relative to an air conditioning unit according to the prior art.

In an expedient development, the fan receptacle forms a housing for a fan wheel associated with the fan. In this manner, the costs for the housing of the fan may be completely saved. Moreover, a finishing step is dispensed with, as the fan wheel is now directly inserted into the fan receptacle. An insertion of the fan wheel into a corresponding housing and a subsequent mounting of the fan with its housing onto the fan receptacle is no longer necessary.

In an expedient development, the fan is designed as a radial fan. In such a radial fan, in blowing mode, air to be delivered is supplied from the center axis of the fan wheel. The conveyed air is conducted to the blades of the fan wheel—as the name “radial fan” indicates—in the radial direction relative to the rotational axis of the fan wheel and blown out of the housing of the fan via an air outlet. Such a radial fan requires less constructional space than an axial fan delivering the same amount of air. By the 90° deflection of the conveyed air, a flow channel extending on the surface of the shell-like seat pan and/or backrest may be impinged by the conveyed air. Thus the flow channel may be molded in a simple manner on the inner face of the seat pan and/or the backrest facing the cushion. In particular, the flow channel may pass on the side of the seat pan and/or the backrest facing the upholstery as far as its edge, which substantially terminates with the upper face of the seat pan or backrest upholstery.

In principle, the radial fan is also able to be used in sucking mode. In other words, the conveyed air is sucked from the surface of the seat pan and/or backrest upholstery towards the fan. Henceforth, for the sake of simplicity, only the blowing mode of the fan will be discussed. However, the fan may also expressly be used in sucking mode.

Advantageously, a flow deflector is provided in particular on the edge of the seat pan and/or the backrest as a connection between the flow channel and the air distribution element. In this manner, the air distribution element, which is arranged flat, substantially on the upper face of the upholstery, may be uniformly impinged by conveyed air from one side.

The air distribution element is advantageously designed as a profiled cushion or as an air distribution mat. The cushion may be provided in a simple manner with such a profiled surface. In a simple manner, therefore, flow channels are formed by the cushion cover on the surface of the upholstery, which distribute the conveyed air on the surface of the upholstery.

An air distribution mat configured by way of example according to the already cited DE 203 20 327 U1, however, represents an element to be attached in an additional manufacturing step, but allows a very uniform distribution of the conveyed air over the surface of the upholstery.

If such an air distribution mat is impinged by conveyed air over the edge of the seat pan or the backrest by means of the already disclosed flow deflector, a particularly uniform distribution of the conveyed air may already be achieved away from the edge of the surface of the upholstery.

In an advantageous development, the flow channel comprises supporting contours facing the upholstery and is designed to be open towards the upholstery. In other words, the flow channel is only sealed and completed by the upholstery inserted into the seat pan and/or into the backrest. By the provision of supporting contours, it is possible to influence how far the upholstery is pressed in by the body weight of a person sitting on the vehicle seat and how far, therefore, the flow cross section of the flow channel is reduced. By a suitable support of the upholstery, it may thus be able to be achieved that even with a person with a high body weight, a sufficient flow cross section is maintained for the flow of air onto the air distribution element. Moreover, the seat pan and/or the backrest may be produced in one piece without undercuts and thus easily removed from the mold. Thus the simple manufacture of the seat pan and/or backrest is possible as a plastics injection-molded part. For securing the structure of the seat pan and/or backrest the plastics may be designed to be glass fiber-reinforced. As a result of this one-piece design and the comparatively simple component geometry, the air conditioning unit may be integrated in a simple and cost-effective manner into the vehicle seat.

In an advantageous variant, a Peltier element is associated with the flow channel for heating or cooling the incident air. Such a Peltier element has p-doped and n-doped semiconductor dies which, alternately on their upper face and on their lower face, are electrically conductively connected to one another via metal bridges. The metal bridges form at the same time thermal contact faces and are insulated by a cover plate, in particular made of a film or a ceramic. If a current flows through the Peltier element, according to the direction of flow, the upper metal bridges cool down and the lower metal bridges heat up, or vice versa. Thus one of the two cover plates is always heated up and the other accordingly cooled down. The temperature difference between the two cover plates may be predetermined by the electrical power consumption of the Peltier element. Such a Peltier element may be derived from, for example, DE 199 08 967 B4. As such a Peltier element has no moving components, it permits heating or cooling of the air flow without wear. To this end, one of the two cover plates is associated in particular with a wall of the flow channel, whilst the second cover plate is located outside the flow channel. The heating or cooling of the air flow takes place via convection, by the air flow passing over the heated or the cooled cover plate of the Peltier element.

In an expedient development, the first cover plate of the Peltier element forms a wall of the flow channel. Moreover, the second cover plate of the Peltier element forms a wall of a second flow channel connected to the fan. In other words, both cover plates of the Peltier element are impinged by conveyed air. By means of convection, respectively the air passing through one of the two channels and passing over the surface of the two cover places heats up and the air flowing through the respective other channel is cooled. In this manner, it is ensured that it does not lead to heat accumulation on the Peltier element and a possible failure of the Peltier element resulting therefrom. If the surface of the upholstery is to be heated, the heat removed from the Peltier element by means of the conveyed air flow corresponds at the same time to the usable heat. If, on the other hand, the surface of the upholstery is to be cooled, the heat produced by the Peltier element is removed by the second flow channel.

Moreover, care has to be taken that when designing the second channel, the flow resistance has to correspond approximately to the flow resistance of the first flow channel with the downstream air distribution mat. Only in this manner is it ensured that the heat produced by the Peltier element is safely removed in every case.

In an expedient development, the cover plates on their sides facing the flow channels have cooling ribs. In this manner, an improvement of the heat transfer is achieved by convection between the respective cover plate and the air flow passing thereover. The cooling ribs of the flow channel facing the cushion may, moreover, be designed such that they provide a supporting surface for the upholstery. Thus the cooling ribs in the region of the Peltier element additionally fulfill the function of supporting contours for the upholstery.

Expediently, the seat pan and/or the backrest have a molding as a receiving contour for the Peltier element. This may, for example, be designed in the manner of a projection so that the Peltier element may be bonded onto the receiving contour with one of its two cover plates.

In an advantageous development, the second flow channel is molded into the seat pan and/or into the backrest. The wall terminating the second flow channel is in this case formed by a housing cover. In this manner, as in the aforementioned variant without a Peltier element, the seat pan and/or the backrest may be made as a one-piece and integral component. The entire design of the two flow channels is ensured by the housing cover that may also be designed as an integral component. In this case the housing cover may, for example, be made such that it may be pressed in the manner of a snap connection onto the seat pan and/or the backrest.

### BRIEF DESCRIPTION OF THE DRAWINGS

FIG. 1: a first seat pan viewed from its upper face receiving the upholstery.

FIG. 2: a first seat pan viewed from its upper face receiving the upholstery.

FIG. 3: the seat pan of FIGS. 1 and 2 viewed from its lower face with a radial fan.

FIG. 4: a second seat pan viewed from its side receiving seat upholstery with two Peltier elements,

FIG. 5: the seat pan of FIG. 4 viewed from its lower face with a radial fan.

FIG. 6: a housing cover.

FIG. 7: the seat pan of FIG. 5 with the mounted housing cover.

FIG. 8: an air conditioning unit with the seat pan of FIG. 7 in a centrally sectioned side view.

### DETAILED DESCRIPTION OF THE INVENTION

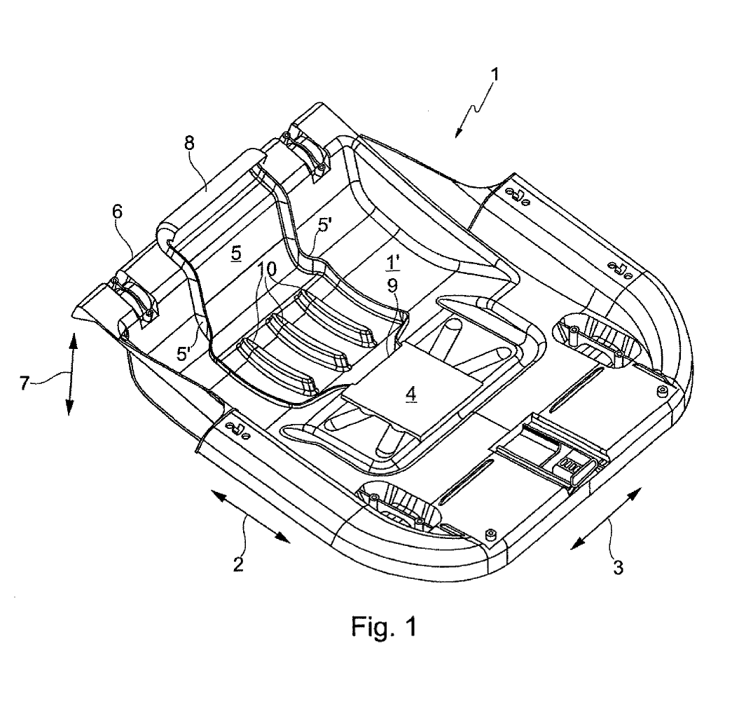

FIG. 1 shows a first seat pan 1 of a motor vehicle seat, not shown in the figures. The seat pan 1 is designed in the manner of a trough for receiving seat pan upholstery, not shown in this and the following figures. It is made in one piece as a glass fiber-reinforced plastics injection-molded part. Viewed in the center from its longitudinal direction 2 corresponding to the motor vehicle longitudinal direction in the final assembled state and the transverse direction 3, the seat pan 1 has a fan receptacle 4 of plate-shaped design. Two channel walls 5′ extending in the longitudinal direction 2 and projecting from the surface 1′ of the seat pan are formed away from the fan receptacle 4 for forming a flow channel 5. The channel walls 5′ and thus the flow channel 5 extend as far as the seat pan edge 6. As may be derived from FIG. 1, the flow channel 5 extends away from the fan receptacle 4, initially substantially in the longitudinal direction 2 and then in the vertical direction 7.

Onto the seat pan edge 6 is attached in the final assembled state of the motor vehicle seat in the vertical direction 7 a backrest that is similarly of trough-like configuration and not shown in the figures. At the seat pan edge 6 the flow channel 5 terminates in a molded-on flow deflector 8. The end of the flow deflector 8, as the end of the flow channel 5, is substantially aligned in the longitudinal direction 2.

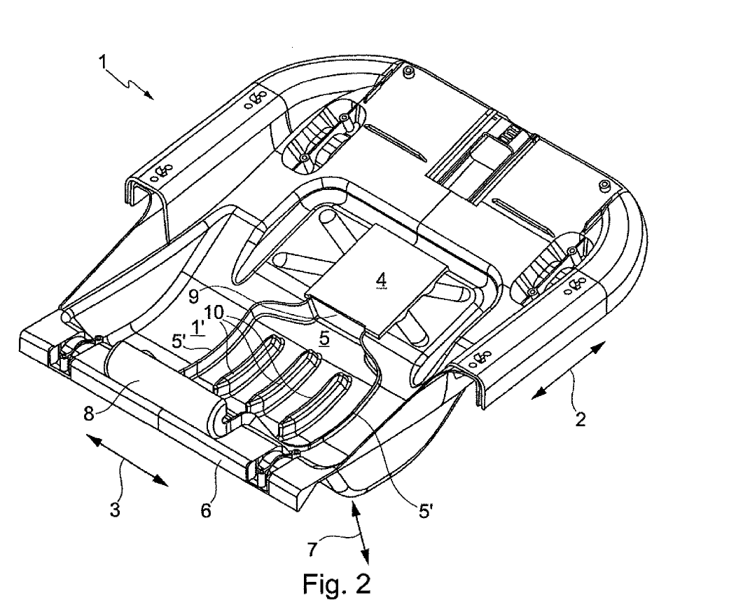

FIG. 2 indicates that the fan receptacle 4 is of plate-like configuration relative to the structure of the seat pan 1 and provides a fan outlet 9 that substantially connects the upper face 1′ and the lower face 1″ of the seat pan 1 to one another. Moreover, in the flow channel 5 three supporting contours 10 designed as cushion support ribs and projecting from the upper face 1′ of the seat pan 1 in the vertical direction 7 are formed in the longitudinal direction 2.

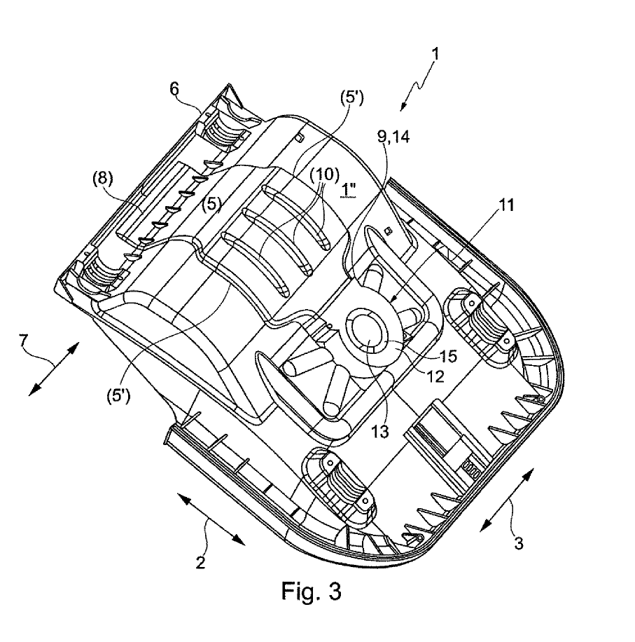

FIG. 3 shows the seat pan of FIGS. 1 and 2 viewed from its lower face 1″. Moldings that are formed on the surface 1′ of the seat pan as raised portions may in this case be seen as recesses. For the sake of a clearer overall view, the corresponding reference numerals are placed in parenthesis. A radial fan 11 is fastened to the fan receptacle 4 of the seat pan 1, viewed from its lower face 1″. The radial fan 11 has a housing 12 in which a fan wheel 13 is rotatably mounted. The radial fan 11 is connected via a fan outlet 14 to the outlet opening 9 of the seat pan 1. Moreover, it has a fan inlet 15 for the supply or removal of conveyed air. In this case, the terms “fan outlet 14” and “fan inlet 15” refer to a blowing mode of the radial fan 11. The radial fan 11 is, however, also able to be used in sucking mode. In this case, the fan outlet 14 and the fan inlet 15 are reversed. However, hereinafter in principle reference is made to blowing mode of the radial fan 11.

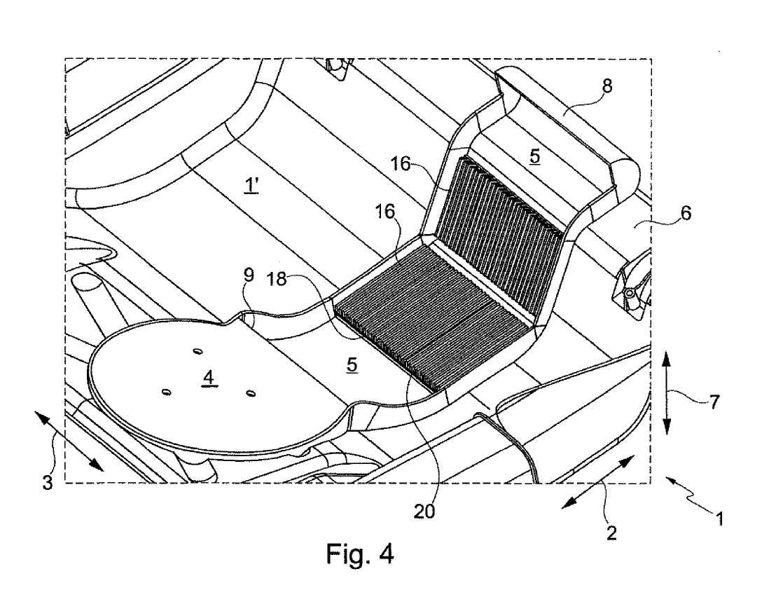

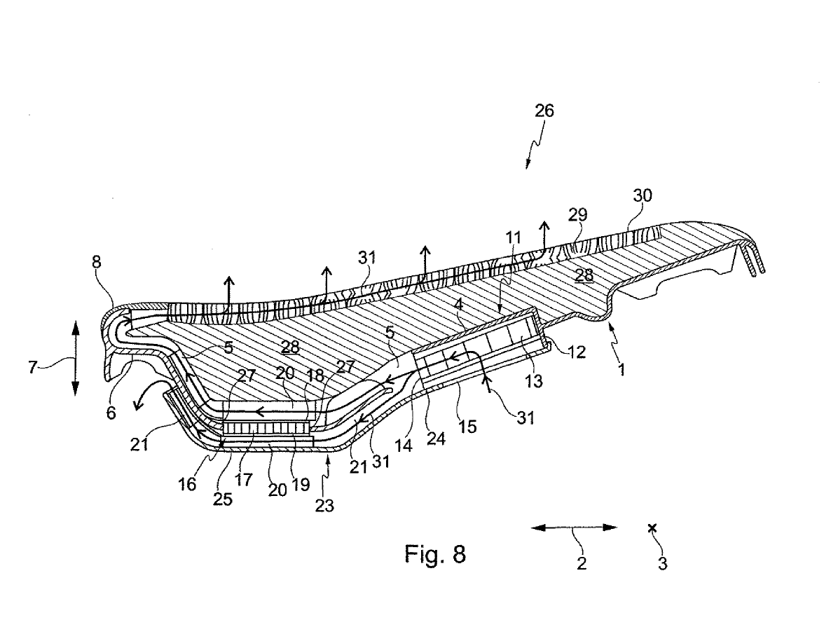

FIG. 4 shows a detail of a second seat pan 1 that substantially corresponds to the seat pan of FIGS. 1 to 3, viewed from the upper face 1′ receiving the seat upholstery. Two Peltier elements 16 are arranged in the flow channel 5. The construction of such a Peltier element 16 is revealed, in particular, from FIG. 8 in which for the sake of an improved overview, however, only one Peltier element 16 is illustrated. Each Peltier element 16 has an n-p-region 17 shown only schematically in FIG. 8, in which in alternate sequence n-doped and p-doped semiconductor dies are conductively connected to one another via metal bridges. Above and below the n-p-region are arranged an upper and a lower cover plate 18, 19. In turn, cooling ribs 20 arranged in the longitudinal direction 2 are fastened to the two cover plates 18, 19. In FIG. 4, only the upper cover plates 18 of the two Peltier elements 16 as well as the cooling ribs 20 arranged thereon may be seen. In other words, the two Peltier elements 16 are fastened to the seat pan 1 such that only the upper cover plate 18 projects into the flow channel 5 with the cooling ribs 20 arranged thereon. The two Peltier elements 16 thus form a part of a wall of the flow channel 5. Supporting contours for the seat pan upholstery are not provided in the second variant of the seat pan 1.

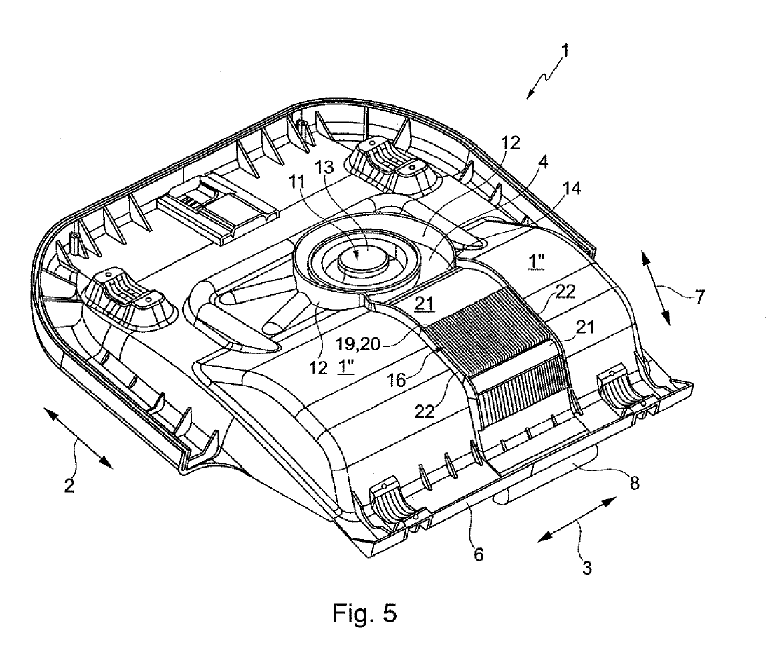

FIG. 5 shows the seat pan 1 of FIG. 4 viewed from its lower face 1″. On the lower face 1″ of the seat pan 1 a second flow channel 21 leading from the fan receptacle 4 to the seat pan edge 6 is formed by two channel walls 22 formed in the seat pan 1. The two Peltier elements 16 form with their lower cover plates 19 and the cooling ribs 20 arranged thereon a part of a wall of the second flow channel 21. Viewed towards the middle of the seat pan 1, the two channel edges 22 open out into the fan receptacle 4. The housing walls 12′ of the housing 12 of the radial fan 11 are formed by moldings in the seat pan 1. A fan wheel 13 is rotatably mounted in the middle of the fan receptacle 4. The fan outlet 14 and the outlet opening 9 correspond in this case, via which both flow channels 5, 21 are connected to the radial fan 11. This is, in turn, able to be seen from FIG. 8.

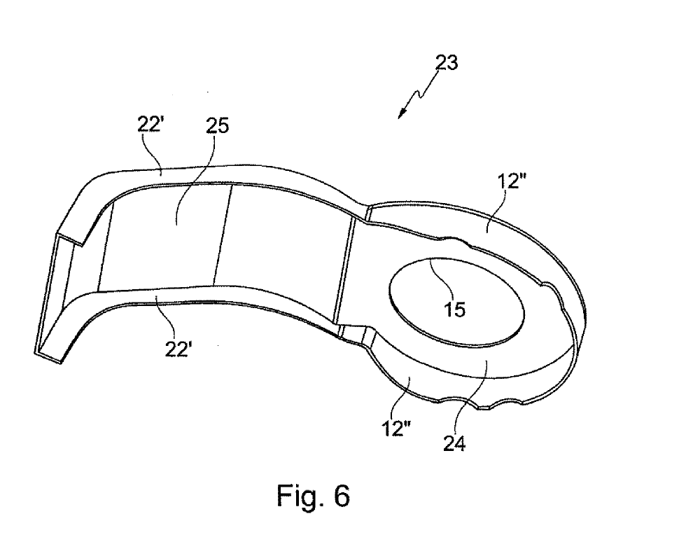

FIG. 6 shows a housing cover 23 that may be placed onto the fan receptacle 4 and the second flow channel 21. The housing cover 23 has a housing portion 24 in the manner of a hole circle and a strip-like flow channel portion 25. Moreover, the housing portion 24 comprises housing walls 12′ and the flow channel portion 25 comprises channel walls 22′. The center region, in the manner of a hole circle, of the housing portion 24 is configured as a fan inlet 15.

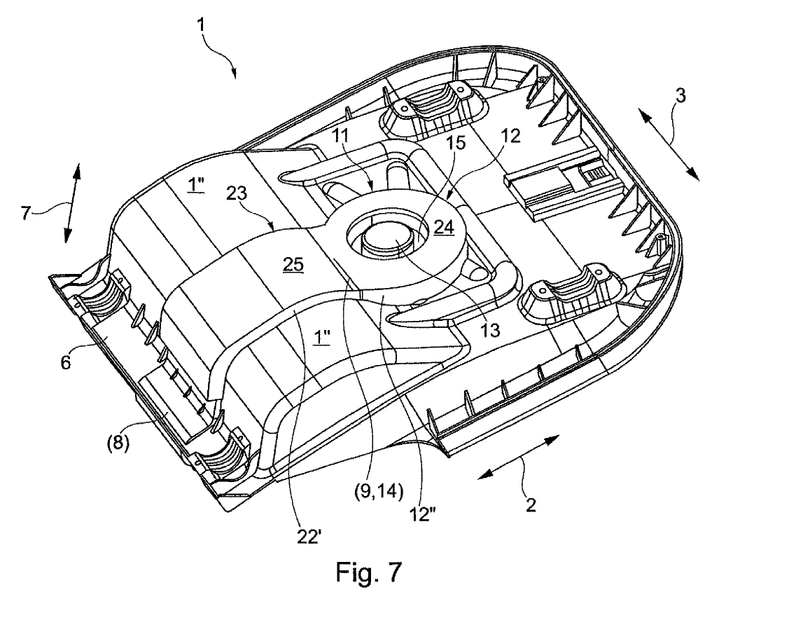

FIG. 7 shows the housing cover 23 in the mounted state. To this end, the housing cover 23 is placed from below with its housing portion 24 and its housing walls 12″ onto the housing walls 12′ surrounding the fan receptacle 4. Moreover, the flow channel portion 25 is positioned with its channel walls 22′ onto the channel walls 22 of the flow channel 21. Thus the housing 12 of the radial fan 11 is formed from the fan receptacle 4 with the housing wall 12′ surrounding the fan receptacle and the housing portion 24 with the housing walls 12″. The flow channel portion 25 terminates the second flow channel 21 with its channel walls 22′.

FIG. 8 shows an air conditioning unit 26 in the final assembled state with the seat pan 1 of FIGS. 5 and 7 in a side view sectioned in the longitudinal direction 2. For the sake of simplicity, in FIG. 1 one of the two Peltier elements 16 is omitted. The Peltier element 16 is arranged in a receiving contour in the seat pan 1 configured as a recess, and namely such that its upper cover plate 18 forms a wall of the first flow channel 5 and its lower cover plate 19 forms a wall of the second flow channel 21. Seat pan upholstery 28 is fastened in the seat pan 1. The seat pan upholstery 28 closes the first flow channel 5 at the top. To this end, it rests against the channel edge 7 of the flow channel. The cooling ribs 20 of the upper cover plate 18 additionally support the upholstery. The seat pan upholstery 28 consists of a substantially airtight foam material. On the upper face of the seat pan upholstery 28 an air distribution mat 29 is arranged. In the region of the seat pan edge 6 the air distribution mat adjoins almost seamlessly the end of the end of the first flow channel 5 formed by the flow deflector 8. Above the air distribution mat 29 an air impermeable cushion cover 30 is fastened, which fixes the air distribution mat 29 in its position.

The function of the air conditioning unit 26 is disclosed below. In FIG. 8 the flow direction 31 for the radial fan 11 is illustrated in blowing mode. By means of its rotating fan wheel 13 the radial fan 11 sucks conveyed air through its fan inlet 15. The conveyed air is radially moved towards the ends of the fan wheel 13. As a result, the fan outlet 9, 14 is impinged by the conveyed air. Both flow channels 5, 21 are impinged by the conveyed air. The conveyed air is distributed over the two flow channels 5, 21. A first partial flow of the conveyed air flows through the first flow channel 5 and passes over the upper cover plate 18 and the cooling ribs 20 of the Peltier element 16. The Peltier element 16 is subjected to a supply voltage such that either the upper cover plate 18 is heated and the lower cover plate 19 is cooled, or vice versa. In other words, the airflow flowing over the cooling ribs 20 is either heated or, however, cooled by convection. The cooling ribs 20 at the same time improve the heat transfer. The airflow passes via the first flow channel 5 as far as the flow deflector 8 on the seat pan edge 6. Air flows onto the air distribution mat 28 from the side out of the flow deflector 8, as the end of the first flow channel 5. The conveyed air is distributed in the flow direction 31 in a two-dimensional manner on the air distribution mat 29 and thus on the surface of the motor vehicle seat. As a result of the cushion cover 30 designed to be impermeable to air, the conveyed air comes into contact with the surface of the motor vehicle seat and cools and/or heats the seat and the undersides of the upper leg of a person sitting on the vehicle seat. The airflow flowing through the second flow channel 21 is directed over the lower cover plate 19 and its cooling ribs 20. In this case, the airflow is either heated or cooled depending on the switched state of the Peltier element 16.

The second flow channel 21 is provided to avoid heat accumulation in the region of the Peltier element 16. Moreover, the efficiency of the Peltier element 16 may be increased by a removal of the heat generated by the Peltier element 16. If the upper cover plate 18 of the Peltier element 16 is heated, the heating of the airflow ensures at the same time a removal of the heat from the Peltier element 16. If, however, the upper cover plate 18 is cooled, heat is produced on the lower cover plate 19 that is removed by means of the second flow channel 21. When designing the flow channels 5, 21 care has to be taken that both flow channels 5, 21 have a comparable flow resistance, as otherwise the airflow might be markedly greater through one of the two flow channels 5, 21 than through the other. The result would be a considerable reduction in the cooling capacity and thus the efficiency of the Peltier element 16.

The radial fan 11 is also able to be used in sucking mode, i.e. the flow direction 29 is reversed and an airflow is sucked from the air distribution mat 27 through the radial fan 11. In this case, the Peltier element 16 is switched off.

The seat pan 1 shown in FIGS. 1 to 3, corresponds substantially to the variant shown in FIG. 8. As, however, in this seat pan no Peltier element 16 is provided, the air distribution mat 27 is impinged by conveyed air at the internal temperature of the vehicle.

What is claimed is:

1. A vehicle seat comprising an air conditioning unit associated with the seat pan and/or the backrest, the air conditioning unit comprising
a fan,
a flow channel and
an air distribution element arranged on the upper face of the seat pan and/or backrest upholstery and connected to the fan via the flow channel,
wherein a fan receptacle molded into the seat pan and/or into the backrest and
a flow channel molded into the seat pan and/or the backrest.

2. The vehicle seat according to claim 1, wherein the fan receptacle forms a housing for a fan wheel associated with the fan.

3. The vehicle seat according to claim 1, wherein the fan is a radial fan.

4. The vehicle seat according to claim 1, further comprising a flow deflector arranged on the edge of the seat pan and/or the backrest as a connection between the flow channel and the air distribution element.

5. The vehicle seat according to claim 1, further comprising a profiled portion in the upholstery or an air distribution mat as an air distribution element.

6. The vehicle seat according to claim 1, wherein the flow channel has at least one supporting contour facing the upholstery and that is open towards the upholstery.

7. The vehicle seat according to claim 1, further comprising a Peltier element in the flow channel for heating or for cooling the incident air.

8. The vehicle seat according to claim 7, further comprising a receiving contour for the Peltier element molded into the seat pan and/or into the backrest.

9. The vehicle seat according to claim 7, further comprising two opposing cover plates encompassing the Peltier element,
the first cover plate forming a wall of the flow channel and
the second cover plate forming a wall of a second flow channel connected to the fan.

10. The vehicle seat according to claim 9, further comprising
moldings in the seat pan and/or in the backrest forming the side walls of the second flow channel and
a housing cover sealing the second flow channel.
